(19) United States
(12) Patent Application Publication
(10) Pub. No.: US 2025/0140098 A1
(43) Pub. Date: May 1, 2025

(54) PROXIMITY DETECTION FOR LIFE SAFETY DEVICES

(71) Applicant: Microchip Technology Incorporated, Chandler, AZ (US)

(72) Inventors: Patrick McFarland, Gilbert, AZ (US); Arthur Eck, Gilbert, AZ (US)

(73) Assignee: Microchip Technology Incorporated, Chandler, AZ (US)

(21) Appl. No.: 18/630,327

(22) Filed: Apr. 9, 2024

Related U.S. Application Data
(60) Provisional application No. 63/593,195, filed on Oct. 25, 2023.

(51) Int. Cl. G08B 21/14; G08B 17/103; G08B 21/18; G08B 21/22

(52) U.S. Cl. CPC G08B 21/14; G08B 17/103; G08B 21/182; G08B 21/22

(57) ABSTRACT

An apparatus including a power circuit to receive power from a power supply of a life safety device, and at least one control circuit powered by the power circuit. The control circuit to, in a calibration mode, receive a signal from an ambient light sensor and determine a baseline ambient light level based on the signal from the ambient light sensor. The control circuit to, in a proximity detection mode, receive another signal from the ambient light sensor, compare the other signal from the ambient light sensor to the baseline ambient light level, determine with an analysis that a difference in ambient light from the baseline ambient light level indicates a presence of an object in proximity to the life safety device, and issue an alert indicating the presence of the object in proximity to the life safety device based at least in part on the analysis.

### PRIORITY

This application claims priority to U.S. Provisional Application No. 63/593,195 filed Oct. 25, 2023, the entire contents of which is incorporated herein by reference.

### TECHNICAL FIELD

The present disclosure relates to proximity detection for life safety devices, and, more particularly, to the detection of objects in proximity to life safety devices, such as smoke detectors, toxic gas detectors, without limitation, that may obstruct or impair the function of the life safety devices.

### BACKGROUND

Life safety devices used in residential, commercial, and industrial applications may generally require an unobstructed area around the life safety device to function properly. Sensors such as smoke and toxic gas detectors may require continuous airflow to detect a safety hazard quickly and accurately. Objects such as stacked boxes, spider webs, dust, and shelving can act as obstructions that prevent proper operation and put lives and property at risk. Detecting these issues before a safety event such as a fire or gas leak may require potentially expensive and manual inspections from an operator, through means such as site visits or observation through camera systems. Physical inspections may be infrequent or non-existent in some areas, whether due to cost or remote location. Even if inspections are frequent, if an obstruction presents itself after an inspection, it could be some time before it is discovered.

One approach is to use infrared (IR) light emitting diodes (LEDs) with IR sensitive photodiodes. The IR LEDs are arranged around the life safety device housing and are periodically flashed. The light signal is picked up on the photo diode and then measured to look for reflections, indicating an object in close proximity to the life safety device. However, inventors of examples of the present disclosure have discovered a shortcoming of the use of IR LEDs, as life safety devices may be required to be ultra-low power devices, e.g., smoke detectors with a 10-year battery life and systems that use low-power data communication cables to also power connected life safety devices. Flashing an array of LEDs and measuring with an array of photodetectors may consume a relatively large amount of power as an active sensing system. This may also require separate light emitting and detecting components and increases manufacturing costs for life safety devices.

Examples of the present disclosure may address one or more of these issues.

### SUMMARY

Aspects and examples of the present disclosure provide devices and methods for detecting, based on ambient light, objects in proximity to a life safety device that may obstruct or otherwise impair the operation of the life safety device.

One aspect may include an apparatus. For example, the apparatus may include a power circuit to receive power from a power supply of a life safety device. The apparatus may include at least one control circuit powered by the power circuit. The control circuit may be to, in a calibration mode, receive a signal from an ambient light sensor and determine a baseline ambient light level based on the signal from the ambient light sensor. The control circuit may be to, in a proximity detection mode, receive another signal from the ambient light sensor, compare the other signal from the ambient light sensor to the baseline ambient light level, determine with an analysis that a difference in ambient light from the baseline ambient light level indicates a presence of an object in proximity to the life safety device, and issue an alert indicating the presence of the object in proximity to the life safety device based at least in part on the analysis.

Another aspect may include a method. For example, the method may include, in a calibration mode, receiving a signal from an ambient light sensor of a life safety device and determining a baseline ambient light level for the life safety device based on the signal from the ambient light sensor. The method may include, in a proximity detection mode, receiving another signal from the ambient light sensor, comparing the other signal from the ambient light sensor to the baseline ambient light level, and determining with an analysis that a difference in ambient light from the baseline ambient light level indicates a presence of an object in proximity to the life safety device. In some examples, proximity may be defined by a focal distance of a focal device covering the ambient light sensor. The method may also include issuing an alert indicating the presence of the object in proximity to the life safety device based at least in part on the analysis.

Another aspect may include an article of manufacture. For example, the article of manufacture may include a non-transitory machine-readable medium, which may include instructions that may be loaded and executed by one or more control circuits of a life safety device. The instructions may cause the one or more control circuits to, in a calibration mode, receive a signal from an ambient light sensor of a life safety device and determine a baseline ambient light level for the life safety device based on the signal from the first ambient light sensor. The instructions may cause the control circuit to, in a proximity detection mode, receive another signal from the ambient light sensor, compare the other signal from the ambient light sensor to the baseline ambient light level, and determine with an analysis that a difference in ambient light from the baseline ambient light level indicates a presence of an object in proximity to the life safety device. In some examples, proximity defined by a focal distance of a focal device covering the ambient light sensor. The instructions may further cause the control circuit to, in the proximity detection mode, issue an alert indicating the presence of the object in proximity to the life safety device based at least in part on the analysis.

### BRIEF DESCRIPTION OF THE DRAWINGS

The figures illustrate aspects of the life safety devices including ambient light sensors for detecting obstructions or objects in proximity to the life safety device.

FIG. 1 shows a life safety device including an ambient light sensor for proximity detection, according to examples of the present disclosure.

FIG. 2 shows a life safety device including an ambient light sensor for proximity detection, according to examples of the present disclosure.

FIG. 3 shows a life safety device including an ambient light sensor with a focal device for proximity detection, according to examples of the present disclosure.

FIG. 4A shows a life safety device including an ambient light sensor with a fish eye lens focal device for proximity detection, according to examples of the present disclosure.

FIG. 4B shows a life safety device including an ambient light sensor with a Fresnel lens focal device and zones for proximity detection, according to examples of the present disclosure.

FIG. 4C shows a life safety device including an ambient light sensor and a light pipe focal device and zones for proximity detection, according to examples of the present disclosure.

FIG. 5A shows a life safety device including multiple ambient light sensors for proximity detection, according to examples of the present disclosure.

FIG. 5B shows a life safety device including multiple ambient light sensors for proximity detection, according to examples of the present disclosure.

FIG. 6A shows an unobstructed life safety device including an ambient light sensor for proximity detection, according to examples of the present disclosure.

FIG. 6B shows an obstructed life safety device including an ambient light sensor for proximity detection, according to examples of the present disclosure.

FIG. 7 shows a flow chart for a method of detecting an object in proximity to a life safety device based on ambient light, according to examples of the present disclosure.

FIG. 8 shows a life safety device including an ambient light sensor for proximity detection, according to examples of the present disclosure.

FIG. 9 shows a flow chart for a method of detecting an object in proximity to a life safety device based on ambient light and providing feedback to the system, according to examples of the present disclosure.

FIG. 10 shows a life safety device including an ambient light sensor for proximity detection, according to examples of the present disclosure.

FIG. 11 shows a flow chart for a method of detecting an object in proximity to a life safety device based on ambient light, according to examples of the present disclosure.

FIG. 12 shows a flow chart for a method of detecting an object in proximity to a life safety device that may include multiple ambient light sensors, according to examples of the present disclosure.

The reference number for illustrated elements that appears in multiple different figures has the same meaning across the multiple figures, and the mention or discussion herein of any illustrated element in the context of any particular figure also applies to each other figure, if any, in which that same illustrated element is shown. In some figures, certain elements may be omitted for clarity when discussing aspects or examples of other elements.

### DESCRIPTION

The detection of objects or obstructions in proximity to a life safety device, which may be referred to herein as proximity detection, may help improve device performance and reduce risk to lives and property, diminish or even eliminate the need for manual inspections, and allow for automated reporting. By using sensors that rely on ambient light already in the environment, reduced power may be used compared to devices that must both emit and detect light. The use of an electro-optical sensor, such as a light sensor to measure intensity of ambient light or a color sensor to measure a specific wavelength range of ambient light, may provide low power and precise detection of potential obstructions. These sensors also have the advantage of being low cost, are a passive detection system with no emissions, and are simpler to integrate into a printed circuit board (PCB) or other control circuitry, e.g. a microcontroller (MCU), analog front end (AFE), or other logic circuits, without limitation, potentially reducing mean time between failures and improving reliability.

Any suitable electro-optical sensor, photosensor, or photodetector may be used to detect changes in ambient light in proximity to a life safety device and to perform proximity detection in accordance with the present disclosure. A suitable electro-optical sensor or photodetector that may be used to represent intensity, color, or other measurable properties (or combinations thereof) of ambient light as electrical signals may be referred to herein as an ambient light sensor. Examples of suitable ambient light sensors may include, without limitation, light sensors, color sensors, multispectral sensors, and infrared (IR) sensors. The ambient light sensor could be placed inside or outside the life safety device housing. The ambient light sensor may be covered by a focal device such as a lens through which light passes and is focused on the ambient light sensor. The field of view and focal length could be set near or at the closest distance an object could safely be without obstructing the life safety device, referred to as the focal distance. By setting an appropriate focal distance, objects close to the detector will have a greater impact on light levels than objects further away. The combination of the ambient light sensor and focal device may allow for the detection of obstructions or objects within a predetermined proximity to the life safety device, wherein proximity may be defined by the focal distance. Any suitable type of lens or other light focusing device can be used as the focal device, and some may allow for multiple zones of detection, e.g., a Fresnel lens, other composite lens, light pipes, without limitation.

A device including an ambient light sensor and a control circuit could monitor changes to the intensity of ambient light or spectrum levels, such as red, green and blue, over time and trigger an alert if an obstruction or object is detected within a predetermined proximity to the life safety device over a period of time, the obstruction or object detected within the predetermined proximity to the life safety device responsive to changes to the ambient light or spectrum levels. The device could also take an initial snapshot of the area after installation to compare light or color changes over time. By comparing changes over time transient events and normal variations in ambient light can be accounted for to improve reliability of the system. By periodically (e.g., hourly, daily, or weekly) sensing measurable properties, e.g., intensity or color, of available ambient light in the environment, reduced power requirements can be achieved. In the event a possible obstruction is detected, the periodicity of sensing may be increased to determine if the obstruction is present for a predetermined duration indicating the presence of a continued obstruction. This may reduce the occurrence of false detections for transient events.

Artificial intelligence (AI) including machine learning techniques could be used to train the device to account for periodic variations in the ambient light level, e.g., due to normal ambient light variations within a space based on use of the space, or time of day, without limitation. The AI model can be trained by providing feedback confirming when an alert accurately indicates detection of an obstruction or object in proximity to the device or confirming when an alert indicates a false detection. In this way, different devices in a system of connected devices can be used in different environments with different levels of ambient light. AI and methods or techniques referred to herein typically apply advanced mathematical algorithms—e.g., decision trees, neural networks, regression analysis, principal component analysis (PCA) for feature and pattern extraction, cluster analysis, genetic algorithm, or reinforced learning—to a data set. As an example, an AI model may include weight factors that may be adjusted based on feedback to the system. By adjusting one or more weight factors, the AI model can be trained to provide more accurate results, e.g., more accurately detecting when an object is in proximity to a life safety device such that the operation of the life safety device may be affected. Examples of the present disclosure provide devices and methods to automatically, quickly, easily, and inexpensively detect objects in proximity to life safety devices that might impair device function, and that can improve safety and protect lives and property more efficiently.

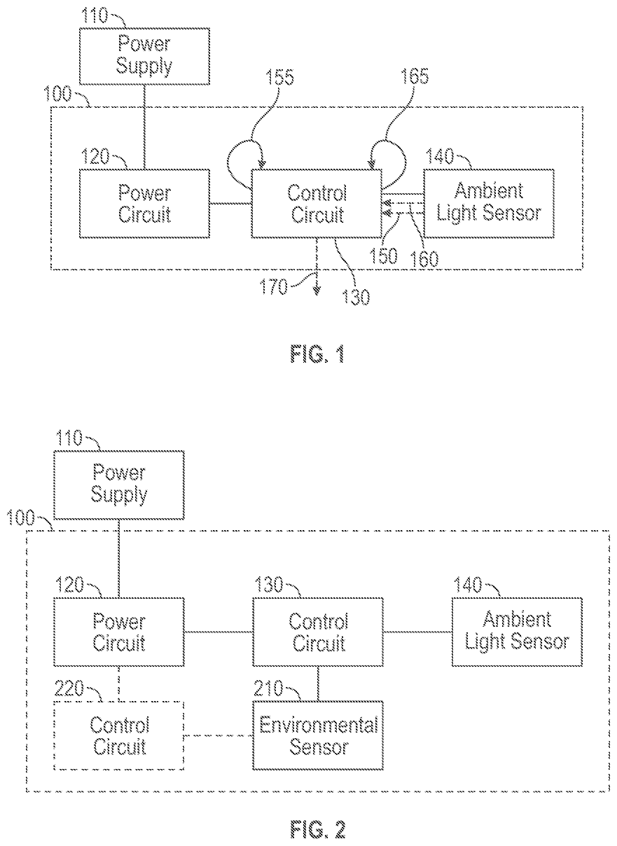

Referring to FIG. 1, there is provided a life safety device 100. Examples of life safety device 100 include an air quality detector, a smoke detector, a heat detector, a carbon monoxide detector, a radon detector, or other toxic gas detector, without limitation, or any suitable combination thereof. Life safety device 100 may include a power supply 110, a power circuit 120, at least one control circuit 130, and an ambient light sensor 140. Power supply 110 may be external to life safety device 100 (as shown) and electrically coupled to power circuit 120 of life safety device 100. Alternatively, power supply 110 may be internal to life safety device 100 (e.g., an internal battery). Power circuit 120 may be electrically coupled to control circuit 130. Ambient light sensor 140 may be communicatively coupled to control circuit 130. Electrical or communicative coupling may be provided by any suitable mechanism for transferring power or signals, e.g., pins, wires, busses, vias, electrical pathways, or any other suitable mechanism. In some examples, communicative coupling may be provided by a wireless connection, e.g., WiFi, Bluetooth, cellular, or any other suitable wireless mechanism or protocol.

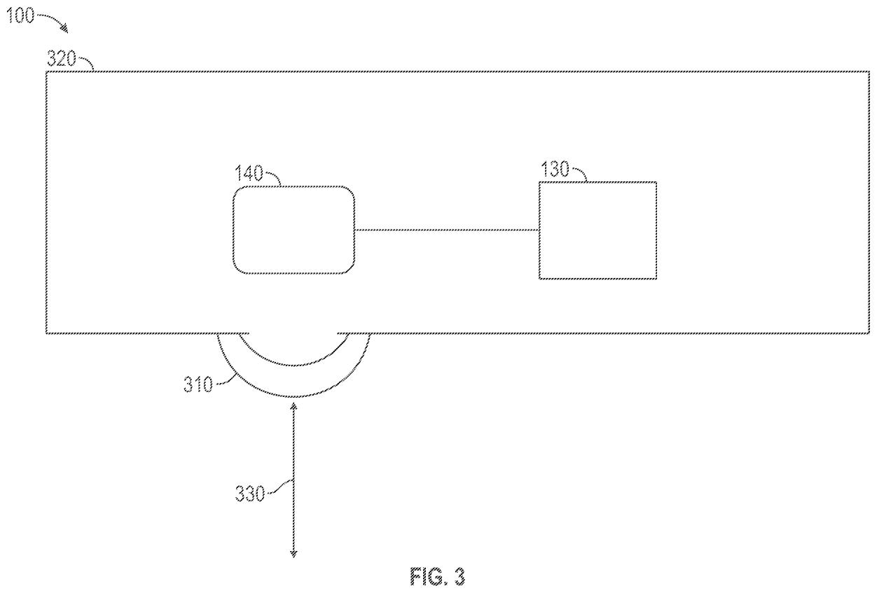

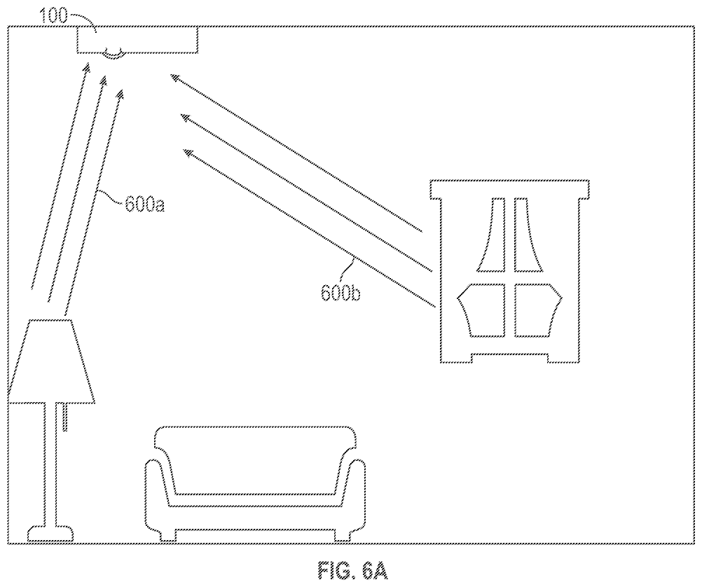

Power supply 110 may provide power to power circuit 120, and power circuit 120 may provide power to other components of life safety device 100. Control circuit 130 may receive power from power circuit 120 and receive electrical signals from ambient light sensor 140 representing the intensity, color, or other measurable properties of ambient light in the environment around life safety device 100. Control circuit 130 may detect one or more objects in proximity to life safety device 100. In a calibration mode, control circuit 130 may receive a first signal 150 from ambient light sensor 140. Control circuit 130 may determine a first baseline ambient light level 155 based on the first signal 150. In a proximity detection mode, control circuit 130 may receive a second signal 160 from ambient light sensor 140. Control circuit 130 may compare the second signal 160 to the first baseline ambient light level 155. Control circuit may determine by a first analysis 165 that a first difference in ambient light from the first baseline ambient light level 155 indicates a presence of an object (not shown) in proximity to the life safety device 100. Control circuit 130 may issue an alert 170 indicating the presence of the object in proximity to life safety device 100 based at least in part on first analysis 165. In this manner, control circuit 130 may detect objects in proximity to life safety device 100 based at least in part on signals 150 and 160 from ambient light sensor 140 and issue an alert 170 when one or more objects are detected based at least in part on a first analysis 165. Control circuit 130 may also receive signals from one or more environmental sensors (shown in FIG. 2) and may control the detection of hazardous conditions (e.g., fire, heat, smoke, or toxic gases, without limitation). In some examples, multiple control circuits 130 (not shown) may be used to perform proximity detection. In some examples, one or more additional control circuits may be used to perform functions of life safety device, as described below in reference to FIG. 2 and FIG. 5a.

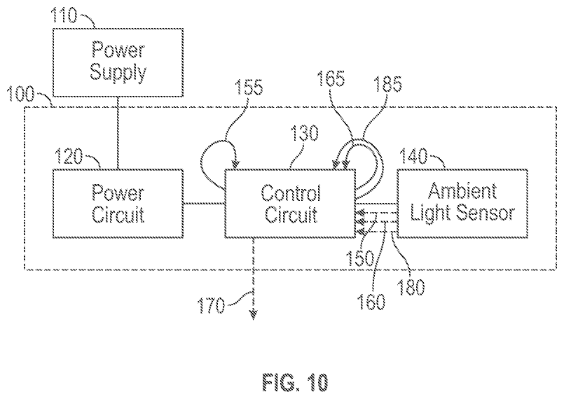

Referring to FIG. 10, there is provided another example of life safety device 100 further including third signals 180 and second analysis 185 in addition to the like numbered elements shown in FIG. 1 and previously described. In the proximity detection mode described with reference to FIG. 1, the second signals 160 received by control circuit 130 from ambient light sensor 140 may be received at a first sampling frequency (e.g., hourly, daily, or weekly, without limitation). Control circuit 130 may determine by a second analysis 185 that a second difference in ambient light from the first baseline ambient light level 155 indicates a presence of an object (not shown) in proximity to the life safety device 100. In some examples, the second analysis 185 may include the following. Control circuit 130 may receive a plurality of third signals 180 from ambient light sensor 140. The plurality of third signals 180 may be received at a second sampling frequency, the second sampling frequency being higher than the first sampling frequency (e.g., every second or every minute, without limitation). Control circuit 130 may calculate an average ambient light level based on at least two of the plurality of third signals 180 received at the second sampling frequency. Control circuit 130 may compare the calculated average ambient light level to the first baseline ambient light level 155. The alert 170 indicating the presence of an object in proximity to the life safety device 100 may be issued based at least in part on the second analysis 185. In some examples, a threshold value for a difference between the calculated average ambient light level to the first baseline ambient light level 155 may be used by control circuit 130 to determine if an alert 170 should be issued based at least in part on the second analysis 185.

Control circuit 130 may determine changes in ambient light and detect obstructions or objects in proximity to life safety device 100 as described herein. Control circuit 130 may be implemented in any suitable manner, such as by a microcontroller (MCU), analog front end (AFE), an application specific integrated circuit (ASIC), a field programmable gate array (FPGA), a programmable logic device (PLD), state machine, reprogrammable logic or hardware, analog circuitry, digital circuitry, digital logic, or instructions for execution by a processor, or any suitable combination thereof. In some examples, ambient light sensor 140 may be integrated with control circuit 130.

Ambient light sensor 140 may detect light present in the environment around life safety device 100, which may be referred to as ambient light, and provide signals that indicate the intensity or color (or both) of detected light to control circuit 130. Ambient light sensor 140 may be any suitable sensor capable of detecting intensity or color of ambient light, including visible or non-visible spectrums of light. In some examples, life safety device 100 may also include one or more memories (not shown) for storing program instructions to be loaded and executed by control circuit 130 or any other circuit of the present disclosure. The one or more memories may also be used to store other information used during the detection of objects in proximity to life safety device 100, according to examples of the present disclosure.

Referring to FIG. 2, there is provided a more detailed illustration of life safety device 100 according to examples of the present disclosure. As shown in FIG. 2, life safety device 100 may include environmental sensor 210. In some examples, environmental sensor 210 may be communicatively coupled to control circuit 130. Environmental sensor 210 may send signals representing the presence of an environmental hazard (e.g., heat, smoke, fire, or toxic gases, without limitation) to control circuit 130. Control circuit 130 may determine if a hazardous condition is present based on signals received from environmental sensor 210 and may issue an alert to indicate the presence of the environmental hazard in response to receiving the signal from environmental sensor 210. In one example, control circuit 130 may issue an audible alert by causing an audible alarm. In another example, control circuit 130 may issue an alert by sending a signal to a central monitoring station (not shown) or other computing device (e.g., computer, tablet, smart phone, without limitation). Some examples may include a separate control circuit 220 electrically coupled to power circuit 120 and communicatively coupled to environmental sensor 210, as indicated by the dotted lines. Control circuit 220 may to determine if a hazardous condition is present based on signals received from environmental sensor 210 and may issue an alert to indicate the presence of the environmental hazard in response to receiving the signal from environmental sensor 210. Control circuit 220 may be implemented in any suitable manner, such as by an MCU, AFE, ASIC, FPGA, PLD, state machine, reprogrammable logic or hardware, analog circuitry, digital circuitry, digital logic, or instructions for execution by a processor, or any suitable combination thereof.

Environmental sensor 210 may be implemented in any suitable manner and may detect any suitable physical phenomena or condition that may indicate an environmental hazard. In some examples, environmental sensor 210 may provide a signal to a monitor circuit (not shown) that may be communicatively coupled to control circuit 130. The monitor circuit may be implemented in any suitable manner, such as by an MCU, AFE, ASIC, FPGA, PLD, reprogrammable logic or hardware, analog circuitry, digital circuitry, digital logic, or instructions for execution by a processor, or any suitable combination thereof. In some examples, the monitor circuit may be implemented within control circuit 130. In some examples, the monitor circuit may receive signals from environmental sensor 210 and determine whether an environmental hazard is present, for example, by comparing the signal to a threshold value. If the signal received from sensor 210 exceeds the threshold value, the monitor circuit may determine that an alarm should be issued indicating the presence of an environmental hazard. In some examples, the alarm may be audible from an audio device (not shown) of life safety device 100. The audio device may be implemented in any suitable manner, such as by a speaker, horn, or other sound emitting device. In some examples, the alarm may be a signal sent to a central monitoring station or other computing device.

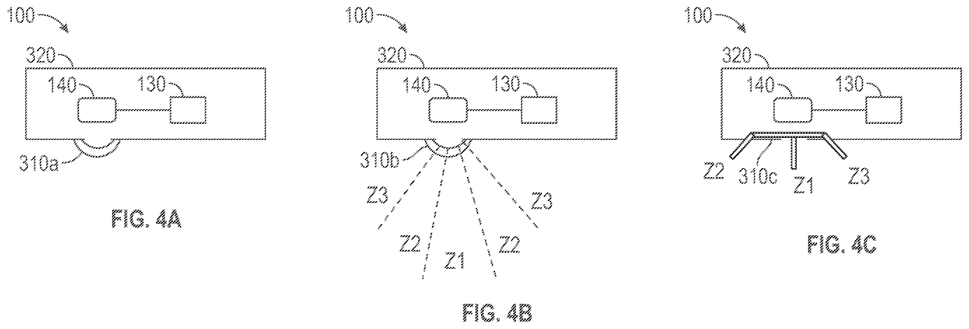

Referring to FIG. 3, there is provided an illustration of life safety device 100 with control circuit 130, ambient light sensor 140, focal device 310, and housing 320. Other aspects and examples of life safety device 100 shown in FIGS. 1 and 2 are omitted for clarity. Focal device 310 may cover ambient light sensor 140 such that light passes through focal device 310 to ambient light sensor 140. Focal device 310 may be any suitable lens or other light focusing device to focus light on ambient light sensor 140. Examples of focal device 310 may include different shaped lenses (e.g., converging lenses, diverging lenses, fisheye lenses, other wide angle lenses, rectilinear lenses, without limitation), composite lenses (e.g., Fresnel lenses without limitation), compound lenses, adjustable lenses, and other light focusing devices such as a light pipe. Focal device 310 may have a predetermined focal distance 330 based on geometry of focal device 310 and its position relative to ambient light sensor 140. Objects at or within focal distance 330 may have a greater impact on the signals produced by ambient light sensor 140. In this manner, proximity to life safety device 100 may be defined by the focal distance 330 of focal device 310. In some examples, focal distance 330 may be set at a minimum safe distance such that objects detected within that distance act as obstructions that may impair the functioning of life safety device 100. In some examples, focal distance 330 may be set at a distance greater than the minimum safe distance to provide a safety factor for detecting objects before they act as obstructions that may impair the functioning of life safety device 100. In some examples, focal device 310 may have a predetermined focal distance 330 of one meter or less.

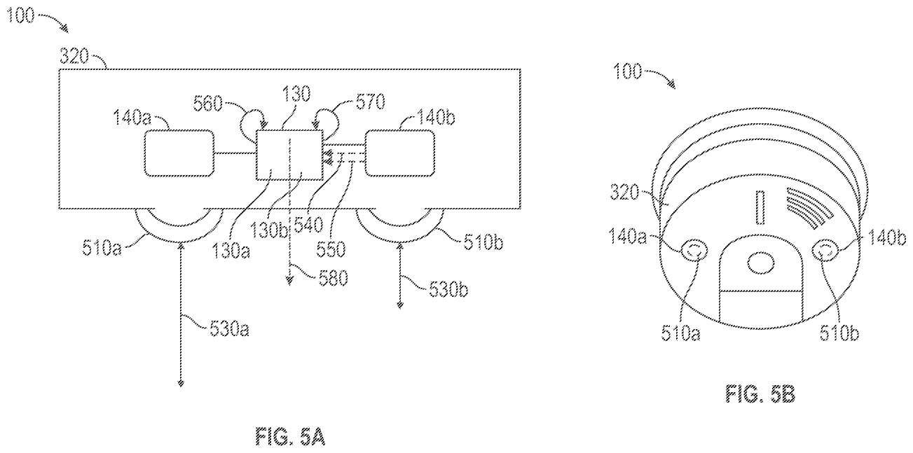

Referring to FIGS. 4A-4C, there are provided different examples for focal device 310 of life safety device 100. FIG. 4A shows the use of a wide-angle lens type focal device 310a such as a fisheye lens for monitoring a wide area. FIG. 4B shows the use of a Fresnel lens type focal device 310b. FIG. 4C shows the use of a light pipe type focal device 310c. Other types of focal devices may also be used. The use of a Fresnel lens type focal device 310b or a light pipe type focal device 310c allows for monitoring multiple zones (e.g., Z1, Z2, Z3) with a single ambient light sensor 140. For example, Fresnel lens type focal device 310b, which is a type of composite lens, may include three different concentric annular sections with different lens geometries that result in different conical zones of detection (Z1, Z2, Z3), which may have different focal distances. As another example, light pipe type focal device 310c may include multiple pipes that may each provide a different zone of detection (Z1, Z2, Z3). Light pipe type focal device 310c may be paired with other types of focal devices, such as lenses, to provide a focal distance that may be used to define proximity. The focal device may be designed to provide a specific focal distance from ambient light sensor 140, e.g., one inch, one foot, or one meter, to determine the proximity of obstructions or objects to the life safety device 100. In some examples, focal devices with variable focal distances may be used to provide a range of object detection.

Referring to FIGS. 5A-5B, there are provided examples of life safety device 100 including housing 320 and one or more control circuits 130 communicatively coupled to a first ambient light sensor 140a and a second ambient light sensor 140b. The second ambient light sensor 140b may be disposed at a different position relative to housing 320 of life safety device 100 than first ambient light sensor 140a. In one example, control circuit 130 may be a single control circuit. In another example, multiple control circuits 130a and 130b may be used. Control circuit 130a may be communicatively coupled to ambient light sensor 140a, and control circuit 130b may be communicatively coupled to ambient light sensor 140b. Ambient light sensors 140a and 140b may be covered by focal devices 510a and 510b, respectively. In some examples, ambient light sensor 140a may interact with control circuit 130 in the same manner as ambient light sensor 140 as described with reference to FIG. 1. In a calibration mode, control circuit 130 may receive a first signal 540 from a second ambient light sensor 140b. Control circuit 130 may determine a second baseline ambient light level 560 based on the first signal 540. In a proximity detection mode, control circuit 130 may receive a second signal 550 from ambient light sensor 140b. Control circuit 130 may compare the second signal 550 to the second baseline ambient light level 560. Control circuit may determine by a second analysis 570 that a second difference in ambient light from the second baseline ambient light level 560 indicates a presence of an object (not shown) in proximity to the life safety device 100. Control circuit 130 may issue an alert 580 indicating the presence of the object in proximity to life safety device 100 based at least in part on second analysis 570.

In some examples, proximity to life safety device 100 may be defined differently for each ambient light sensor 140a and 140b. For a first ambient light sensor 140a, proximity to life safety device 100 may be defined by a first focal distance 530a of a first focal device 510a covering the first ambient light sensor 140a. For a second ambient light sensor 140, proximity to life safety device 100 may be defined by a second focal distance 530b of a second focal device 510b covering the second ambient light sensor 140b. The second focal distance 530b may be different from the first focal distance 530a. As indicated above, ambient light sensors 140a and 140b may be disposed at different positions around housing 320. Focal devices 510a and 510b may be one of the examples previously discussed or any suitable focal device for determining changes in light under ambient lighting conditions that may indicate the proximity of objects or obstructions to life safety device 100. In some examples, multiple ambient light sensors 140 may be used with different types of focal devices or with different focal distances to provide a range of object detection, including, for example, multiple zones of object detection. Although two ambient light sensors and focal devices are shown, more ambient light sensors and respective focal devices may be used.

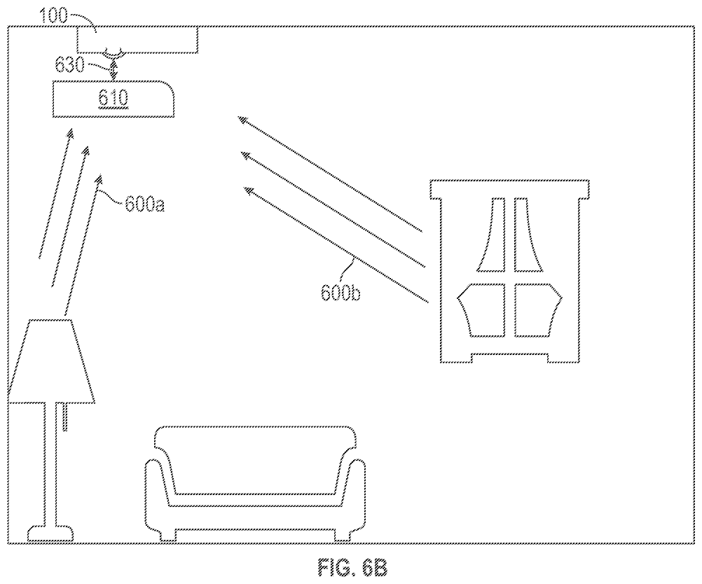

Referring to FIGS. 6A-6B, there is provided an example use of life safety device 100 (including a light sensor, focal device, control circuit and other elements previously described but not shown) to detect an obstruction or object in proximity to life safety device 100. FIG. 6A shows an unobstructed life safety device 100 in a room with multiple sources 600a and 600b of ambient light. The scenario shown in FIG. 6A provides one or more baseline levels of ambient light that life safety device 100 may use as a baseline for comparisons. For example, in a calibration mode, a first baseline may be established during daylight hours with windows uncovered. A second baseline may be established during daylight hours with windows covered. A third baseline may be established with other sources of ambient light (e.g., lighting fixtures) turned on. In some examples, the calibration mode may be performed periodically to develop various baselines for use in proximity detection. In some examples, AI or machine learning models may be used to improve detection by sampling multiple baselines and training the system to recognize different levels or sources of ambient light, e.g., based on intensity, color, or zone of detection, allowing life safety device 100 to detect obstructions in different lighting conditions.

FIG. 6B shows an obstructed life safety device 100 in a room with multiple sources of ambient light 600a and 600b. Object 610 is shown at or within focal distance 630 from life safety device 100 and is obstructing ambient light from reaching the ambient light sensor (not shown) of life safety device 100. The closer object 610 is to life safety device 100, the greater the effect on the ambient light levels, e.g., by obstructing more ambient light. Focal distance 630 may be set to a specific distance to define a predetermined proximity for detection of obstructions or objects, e.g., during a proximity detection mode. In some examples, the focal distance may be set at a sufficient distance that an alert may be triggered for objects that are in close proximity to life safety device 100 but before the objects are close enough to impact the ability of life safety device 100 to detect potential environmental hazards. For example, if an object needs to be within one inch of life safety device 100 to affect its performance as a life safety device, it may be desirable to set the focal distance to one foot or one meter to provide a buffer region where objects may be detected and determined to be in proximity of the life safety device before performance is affected.

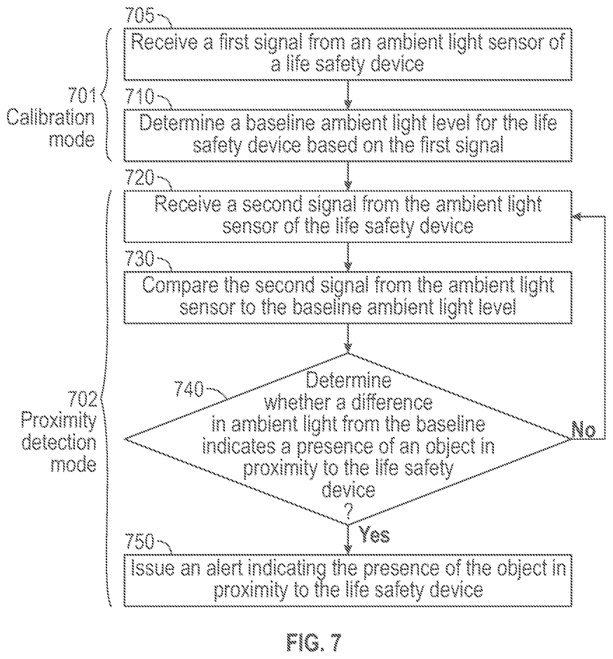

Referring to FIG. 7, a flow chart is provided for an example method 700 of detecting obstructions or objects in close proximity to a life safety device based on changes in ambient light, according to examples of the present disclosure. Method 700 may be performed by any suitable elements, such as control circuit 130 shown in FIGS. 1-5B. In some examples, the method 700 may be executed with more or fewer steps than shown in FIG. 7, and the steps shown in FIG. 7 may be optionally omitted, repeated, performed in a different order, performed in parallel, or recursively.

At 705, a first signal from an ambient light sensor of a life safety device may be received. At 710, a baseline ambient light level for the life safety device may be determined, the baseline ambient light level determined at least responsive to the received first signal form the ambient light sensor. For convenience, and without limitation, the combination of 705 and 710 may be referred to as a calibration mode 701. In the calibration mode 701, one or more baseline ambient light levels may be determined for the one or more ambient light sensors of life safety device 100, e.g., by repeating 705 and 710 for each ambient light sensor or under different ambient light conditions (e.g., at different times of day, with different sources of ambient light in the environment, without limitation).

At 720, a second signal from the ambient light sensor of the life safety device may be received. At 730, the second signal from the ambient light sensor may be compared to the baseline ambient light level. At 740, it may be determined whether a difference in ambient light from the baseline indicates the presence of an object in proximity to the life safety device. If the determination at 740 is no, method 700 may return to 720. If the determination at 740 is yes, method 700 may continue to 750. At 750, an alert indicating the presence of the object in proximity to the life safety device may be issued. For convenience, and without limitation, the combination of 720, 730, 740, and 750 may be referred to as a proximity detection mode 702. In some examples, for life safety devices with multiple ambient light sensors, proximity detection may be performed for each ambient light sensor separately, e.g., including a first analysis for a first ambient light sensor and a second analysis for a second ambient light sensor. In other examples, proximity detection may be performed for multiple ambient light sensors concurrently, e.g., by averaging the signals.

In some examples, the determination at 740 may be performed by a first analysis, e.g., by determining, based on the comparison, that the difference in ambient light from the baseline exceeds a threshold value. In some examples, there may be a respective threshold value associated with each baseline ambient light level determined at 710. In some examples, second signals may be received from multiple ambient light sensors of a life safety device or for different zones and the second signals may be used in combination, e.g. in a weighted average, for a comparison to a single baseline ambient light level, which may also be a weighted average of different baselines, at comparison 730 or a determination at 740. The use of averages may help improve accuracy of proximity detection and reduce false detections.

In some examples, the second signal received at 720 may be received periodically at a first sampling frequency, e.g., hourly, daily, or weekly. The determination at 740 may result in a second determination performed by a more refined second analysis (not shown) before an alert is issued at 750. The second analysis may provide higher confidence in the determination that an object is in proximity to the life safety device. The second analysis may, for example, include increasing the sampling frequency and determining if the reduction in ambient light is detected over a period of time. In some examples, the second analysis may include receiving a plurality of signals from the ambient light sensor at a second sampling frequency over a predetermined duration of time, where the second sampling frequency is higher than the first sampling frequency, e.g., every second or every minute, and calculating an average ambient light level based on at least two of the plurality of signals received at the second sampling frequency over the predetermined duration of time. The average ambient light level may then be compared to the baseline ambient light level to determine, based on the comparison, that the difference in ambient light from the baseline exceeds a threshold value which is indicative that an object is in proximity to the life safety device. The alert at 750 may then be issued based at least in part on the second analysis. In this manner, the life safety device may monitor for potential objects in proximity at a low sampling frequency, then increase the sampling frequency to confirm the presence of an object in proximity over a duration of time. This may also reduce alerts associated with transient events, e.g., objects or obstructions that are in proximity for a sufficiently short amount of time such that the overall operation of the life safety device is not significantly affected.

In some examples, the determination at 740 may result in issuing an alert at 750 if the second signal received at 720 is associated with a specific zone, while a determination at 740 may result in a second analysis if the second signal received at 720 is associated with a different zone. In this manner, there may be a zone where further observation and analysis is performed based on the determination at 740 and a zone where an alert is immediately issued based on the determination at 740. For example, an object near a life safety device but not directly under the life safety device (e.g., in Z2 or Z3 as illustrated in FIGS. 4B-4C) may be less of a concern than an object directly under the life safety device (e.g., in Z1 as illustrated in FIGS. 4B-4C).

In some examples, the alert issued at 750 may be an audible alert, a visual alert, or any other suitable alert. In some examples, the alert may be a message communicated over a communications network communicatively coupled to a control circuit of the life safety device. The communications network may be a wired communications network (e.g., ethernet, power-line communication, fiber optic communication, without limitation) or a wireless communications network (e.g., WiFi, Bluetooth, cellular, without limitation). In some examples, the communications network may also serve as the power supply for the life safety devices (e.g., power over ethernet, or power-line communication without limitation). For example, in a system with multiple life safety devices connected over a communications network (e.g., in an apartment building, office building, or warehouse, without limitation), the alert may be a message communicated to a central monitoring station or other computing device. Based on the alert, appropriate personnel can be dispatched to check the operation of the life safety device and determine whether an object is in proximity to the life safety device such that the operation of the life safety device may be impaired.

In some examples, where multiple life safety devices may be connected over a communications network that also provides power to the life safety devices, different devices may perform proximity detection at different times. For example, the timing for proximity detection for life safety devices may be staggered so that one or a few of the life safety devices perform proximity detection at the same time. This may reduce the overall or peak power consumption of the life safety devices on the network by restricting the number of devices performing proximity detection at the same time.

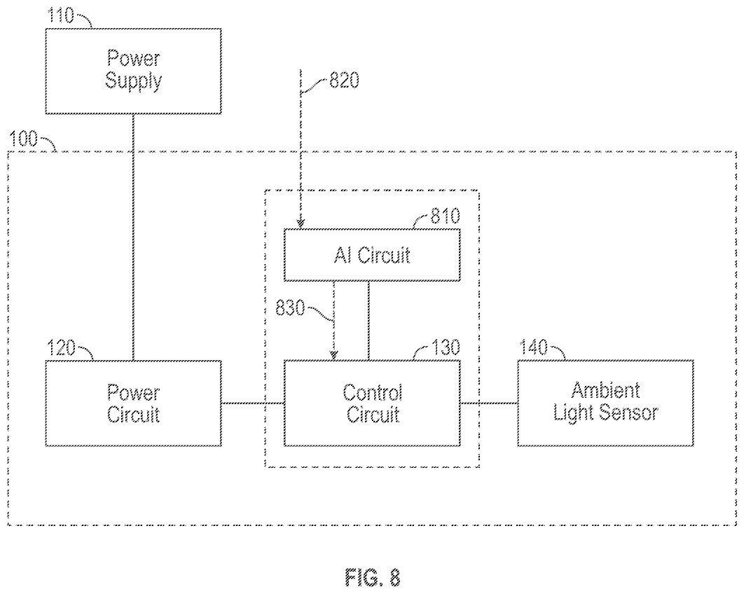

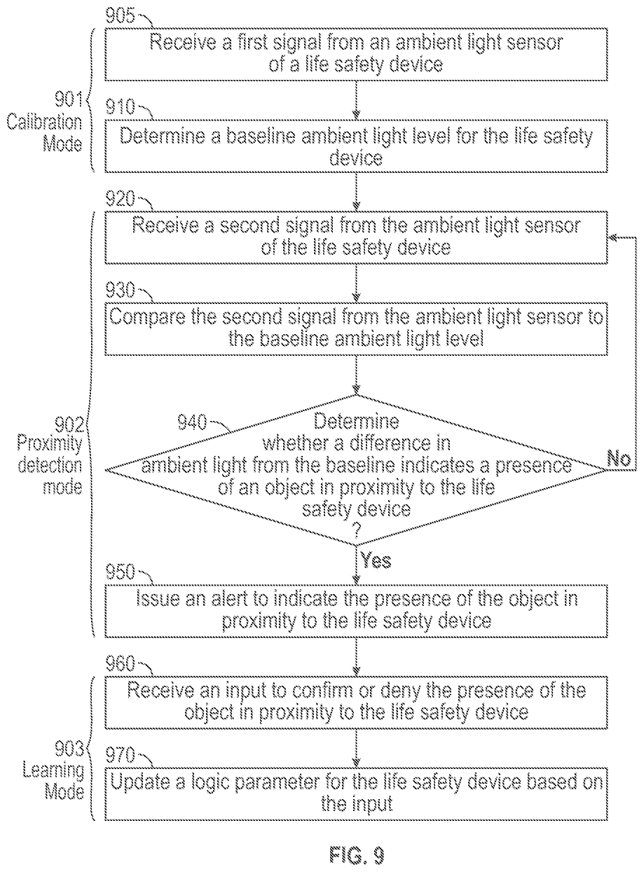

Referring to FIG. 8, there is provided a life safety device 100 including artificial intelligence circuit 810 and other elements previously described. Artificial intelligence circuit 810 (also referred to as AI circuit 810) may be implemented in any suitable manner, such as by an MCU, AFE, ASIC, FPGA, PLD, reprogrammable logic or hardware, analog circuitry, digital circuitry, digital logic, or instructions for execution by a processor, or any suitable combination thereof. In some examples, AI circuit 810 may be communicatively coupled to control circuit 130. In other examples, AI circuit 810 may be integrated with control circuit 130 as shown by the dashed line around AI circuit 810 and control circuit 130. AI circuit 810 may receive feedback via input 820 to confirm or deny the presence of an object in proximity to life safety device 100. AI circuit 810 may provide update 830 to update a logic parameter for control circuit 130 based on input 820. In some examples, updating a logic parameter may include adjusting a weight factor associated with the difference in ambient light from the baseline. In some examples, AI circuit 810 may employ one of numerous methodologies for learning from data or feedback and drawing inferences from data models. For example, AI circuit 810 may monitor the ambient light conditions in proximity to a life safety device over a period of time and recognize recurring patterns in ambient light conditions, e.g., related to time of day or availability of different ambient light sources. In this manner, AI circuit 810 may aid control circuit 130 in determining different baseline ambient light levels and threshold values for different recognized ambient light conditions. In some examples, this may be done as part of a calibration mode or another mode. For example, life safety device 100 may monitor ambient light conditions over a period of days after initial installation, and may use AI circuit 810 to determine appropriate baseline and threshold values for use in proximity detection. AI circuit 810 may also be used to update logic parameters for control circuit 130. In some examples, AI circuit 810 may generate revised software instructions to be executed by control circuit 130. In some examples, AI circuit 810 may adjust one or more weight factors as discussed below in reference to FIG. 9.

Referring to FIG. 9, a flow chart is provided for an example method 900 of detecting obstructions or objects in close proximity to a life safety device based on changes in ambient light and providing feedback. In some examples, this feedback may be used to train an AI model. Method 900 may be performed by any suitable elements, such as control circuit 130 shown in FIGS. 1-5B. In some examples, method 900 may be executed with more or fewer steps than shown in FIG. 9, and the steps shown in FIG. 9 may be optionally omitted, repeated, performed in a different order, performed in parallel, or recursively. In some examples, the methods herein may be included in instructions in a computer readable medium that when loaded and executed by one or more control circuits, e.g., control circuit 130, artificial intelligence circuit 810, any other suitable processor, or a combination thereof, cause the one or more control circuits to carry out the methods, e.g., method 700 or method 900. In some examples, some steps may be carried out by one control circuit and other steps may be carried out by another control circuit.

Steps 905-950, calibration mode 901, and proximity detection mode 902 of method 900 correspond to respective steps 705-750, calibration mode 701, and proximity detection mode 702 of method 700 as described above and are not repeated for brevity. In response to the alert issued at 950, appropriate personnel may be dispatched to check the function of the life safety device, and to inspect whether, or not, there are obstructions present in the proximity thereof, and provide feedback. At 960, an input either confirming or denying the presence of an obstruction or object in proximity to the life safety device. At 970, a logic parameter for the life safety device may be updated based on the input. For convenience, and without limitation, the combination of 960 and 970 may be referred to as a learning mode. In this way, the life safety device can learn patterns that indicate a likely obstruction from those that do not, and accuracy of detection can be improved. In some examples, the learning mode may aid in enabling different life safety devices in a system to be used in different environments with ambient light conditions. The method may return to 920 to continue periodic detection of ambient light.

In some examples, a logic parameter for the life safety device may be updated at 970 by generating revised software instructions to be executed by a control circuit or other processor, without limitation. In some examples, a logic parameter for the life safety device may be updated at 970 by adjusting a weight factor, e.g., a weight factor associated with a difference in ambient light from the baseline that may indicate a presence of an object in proximity to the life safety device. In some examples, weight factors may include factors related to threshold values, time of day, general changes in ambient light conditions observed over time, certain recognized patterns of changes in ambient light conditions, different ambient light sensors, different zones, weighted averaging of different signals, and any other suitable factors used in the detection of objects in proximity to life safety devices. In some examples, updating a weight factor may include increasing or decreasing the weight a certain factor is given when determining whether a difference in ambient light from a baseline ambient light level indicates the presence of an object or obstruction in proximity to the life safety device. For example, if in response to an alert dispatched personnel determine there is no object in proximity to the life safety device, or the object detected is not in close enough proximity to the life safety device to be considered an obstruction, a weight factor may be decreased to give less weight to a specific ambient light sensor, zone of detection, or other weight factor under certain ambient lighting conditions or patterns. As another example, if dispatched personnel determine there is an object in proximity to the life safety device, a weight factor may be increased to give more weight to a specific ambient light sensor, zone of detection, or other weight factor under certain ambient lighting conditions or patterns. In this manner, the life safety device may be trained to provide more accurate proximity detection over time by increasing or decreasing the likelihood of an alert being issued under similar conditions or patterns.

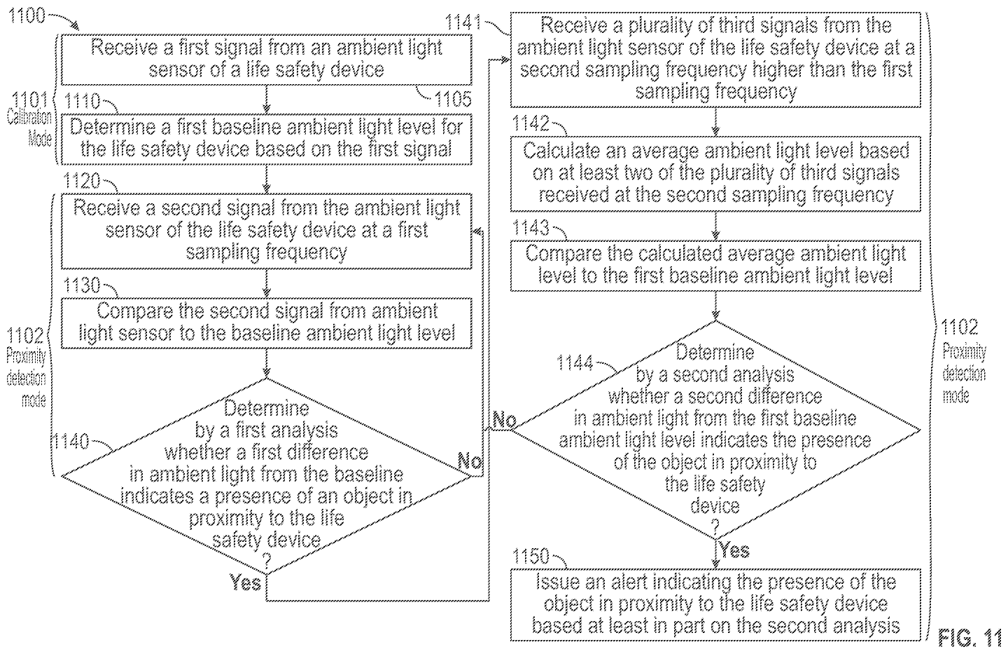

Referring to FIG. 11, a flow chart is provided for an example method 1100 of detecting obstructions or objects in close proximity to a life safety device based on changes in ambient light. In some examples, certain aspects of method 1100 may be implemented similarly to corresponding aspects of methods 700 or 900. In some examples, the method 1100 may be executed with more or fewer steps than shown in FIG. 11, and the steps shown in FIG. 11 may be optionally omitted, repeated, performed in a different order, performed in parallel, or recursively. At 1105, a first signal from an ambient light sensor of a life safety device may be received. At 1110, a baseline ambient light level for the life safety device may be determined, the baseline ambient light level determined at least responsive to the received first signal form the ambient light sensor. For convenience, and without limitation, the combination of 1105 and 1110 may be referred to as a calibration mode 1101. In the calibration mode 1101, one or more baseline ambient light levels may be determined for the one or more ambient light sensors of life safety device 100, e.g., by repeating 1105 and 1110 for each ambient light sensor or under different ambient light conditions (e.g., at different times of day, with different sources of ambient light in the environment, without limitation).

At 1120, a second signal from the ambient light sensor of the life safety device may be received at a first sampling frequency, e.g., hourly, daily, or weekly. At 1130, the second signal from the ambient light sensor may be compared to the baseline ambient light level. At 1140, it may be determined by a first analysis whether a first difference in ambient light from the baseline indicates the presence of an object in proximity to the life safety device. In some examples, the first analysis at 1140 may include determining, based on the comparison, that the difference in ambient light from the baseline exceeds a threshold value. If the determination at 1140 is no, method 1100 may return to 1120. If the determination at 1140 is yes, method 1100 may proceed to 1141. At 1141, a plurality of third signals from the ambient light sensor of the life safety device may be received at a second sampling frequency that is higher than the first sampling frequency, e.g., every second or every minute. At 1142, an average ambient light level may be calculated based on at least two of the plurality of third signals received at the second sampling frequency at 1141. At 1143, the calculated average ambient light level of 1142 may be compared to the baseline ambient light level. At 1144, it may be determined by a second analysis whether a second difference in ambient light from the baseline ambient light level indicates a presence of the object in proximity to the life safety device. In this manner, method 1100 may include increasing the sampling frequency and determining if the reduction in ambient light is detected over a period of time. If the determination at 1144 is no, then method 1100 may return to 1120. If the determination at 1144 is yes, then method 1100 may proceed to 1150. At 1150, an alert indicating the presence of the object in proximity to the life safety device may be issued. For convenience, and without limitation, the combination of 1120, 1130, 1140, 1141, 1142, 1143, 1144, and 1150 may be referred to as a proximity detection mode 1102. In this manner, the life safety device may monitor for potential objects in proximity at a low sampling frequency, then increase the sampling frequency to confirm the presence of an object in proximity over a duration of time. This may also reduce alerts associated with transient events, e.g., objects or obstructions that are in proximity for a sufficiently short amount of time such that the overall operation of the life safety device is not significantly affected.

In some examples, there may be a respective threshold value associated with each baseline ambient light level determined at 1110. In some examples, second signals may be received from multiple ambient light sensors of a life safety device or for different zones and the second signals may be used in combination, e.g., in a weighted average, for a comparison to a single baseline ambient light level, which may also be a weighted average of different baselines, at comparison 1130 or a determination at 1140. The use of averages may help improve accuracy of proximity detection and reduce false detections.

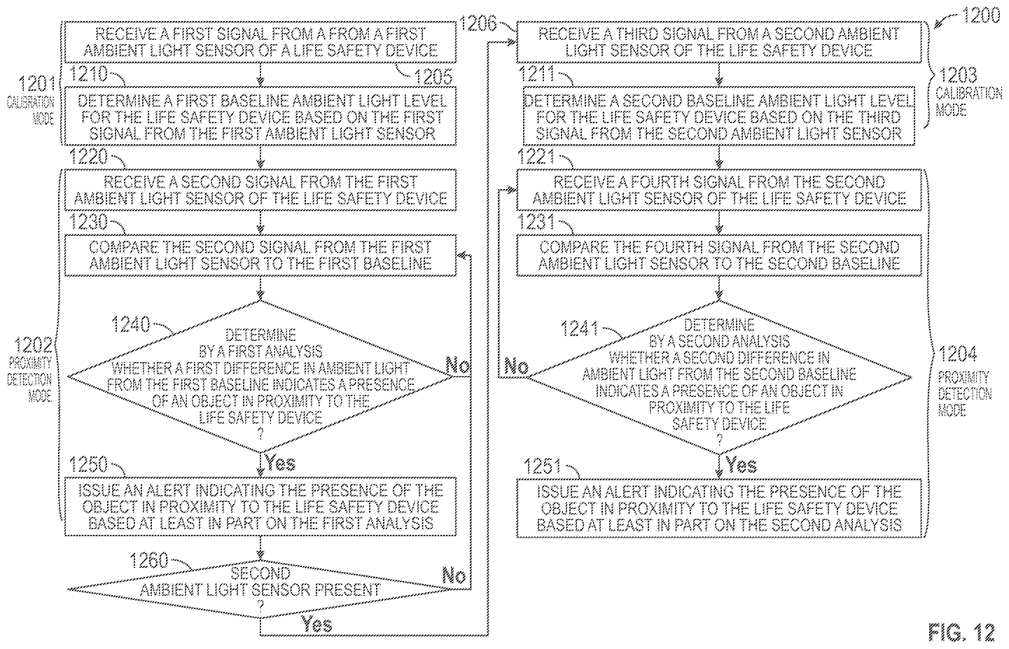

Referring to FIG. 12, a flow chart is provided for an example method 1200 of detecting obstructions or objects in close proximity to a life safety device based on changes in ambient light with multiple ambient light sensors. Steps 1205-1250, of method 1200 correspond to respective steps 705-750 of method 700 as described above for a first ambient light sensor and are not repeated for brevity. The determination at 1240 may be referred to as a first analysis, e.g., when there are multiple ambient light sensors. In some examples, method 1200 may be executed with more or fewer steps than shown in FIG. 12, and the steps shown in FIG. 12 may be optionally omitted, repeated, performed in a different order, performed in parallel, or recursively. At 1260 it may be determined whether a second ambient light sensor is present for the life safety device, e.g., as shown and described for FIGS. 5A and 5B. If at 1260 a second ambient light sensor is not present, method 1200 may return to 1220 and continue to monitor for objects or obstructions in proximity to the life safety device as described herein. If at 1260 a second ambient light sensor is present, method 1200 may continue to 1206. At 1206, an initial signal, which may be referred to as a third signal for convenience, may be received from a second ambient light sensor of the life safety device. Step 1206 may be implemented similarly to step 1205 for the first ambient light sensor. At 1211, a second baseline ambient light level for the life safety device may be determined based on the third signal from the second ambient light sensor. Step 1211 may be implemented similarly to step 1210 for the first ambient light sensor. At 1221, a fourth signal may be received from the second ambient light sensor of the life safety device. Step 1221 may be implemented similarly to step 1220 for the first ambient light sensor. At 1231, the fourth signal from the second ambient light sensor may be compared to the second baseline ambient light level. Step 1231 may be implemented similarly to step 1230 for the first ambient light sensor. At 1241, it may be determined by a second analysis (relative to the first analysis of 1240) whether a second difference in ambient light from the second baseline indicates a presence of an object in proximity to the life safety device. If the determination is no, method 1200 may return to 1221 for the second ambient light sensor. If the determination is yes, method 1200 may proceed to 1251. At 1251, an alert indicating the presence of the object in proximity to the life safety device may be issued based at least in part on the second analysis at 1241. In some examples, the determinations at 1240 and 1241 may be combined to issue a single combined alert at 1250 and 1251. In some examples, signals may be received at 1220 and 1221 from the multiple ambient light sensors of a life safety device or for different zones and may be used in combination, e.g. in a weighted average, for a comparison to a single baseline ambient light level, which may also be a weighted average of different baselines. The use of averages may help improve accuracy of proximity detection and reduce false detections.

Additional modes may also be included in any of methods 700, 900, 1100, and 1200. As one example, a hazard detection mode, which may include receiving a signal from an environmental sensor, the signal from the environmental sensor representing the presence of an environmental hazard and issuing an alert to indicate the presence of the environmental hazard in response to receiving the signal from the environmental sensor. This may be useful, for example, where the same control circuit is used for hazard detection and proximity detection. The different modes may operate separately from other modes or concurrently with other modes (e.g., a proximity detection mode may operate concurrently with a hazard detection mode). The different modes referred to herein are intended to aid in the description of the operation of a life safety device in various aspects and examples of the present disclosure and are not intended to limit how those modes are implemented. For example, the calibration, proximity detection, and learning modes referred to herein may be performed by programming logic executed by a control circuit, without restriction on how that programming logic is implemented, organized, or structured. Various programming languages and compilation methods can be used. Programming logic may be organized or structured as a single software program, as software modules, or as software functions with function calls, or any other suitable organization or structure.

In some aspects, an article of manufacture, comprising a non-transitory machine-readable medium, the medium including instructions that, when loaded and executed by a control circuit of a life safety device, cause the control circuit to perform the various methods (e.g., the methods of FIGS. 7, 9, 11 and 12) and other functions of the life safety device as described in the present disclosure.

While the present disclosure has been described herein with respect to certain illustrated examples, those of ordinary skill in the art will recognize and appreciate that the present invention is not so limited. Rather, additions, deletions, and modifications to the illustrated and described examples may be made without departing from the spirit and scope of the present disclosure and aspects hereinafter claimed along with their legal equivalents. In addition, features from one example may be combined with features of another example while still being encompassed within the scope of the present disclosure as contemplated and described.

What is claimed is:

1. An apparatus, comprising:
a power circuit to receive power from a power supply for a life safety device;
at least one control circuit powered by the power circuit to:
in a calibration mode:
receive a first signal from a first ambient light sensor;
determine a first baseline ambient light level based on the first signal from the first ambient light sensor;
in a proximity detection mode:
receive a second signal from the first ambient light sensor;
compare the second signal from the first ambient light sensor to the first baseline ambient light level;
determine by a first analysis that a first difference in ambient light from the first baseline ambient light level indicates a presence of an object in proximity to the life safety device; and
issue an alert indicating the presence of the object in proximity to the life safety device based at least in part on the first analysis.

2. The apparatus of claim 1, wherein proximity to the life safety device is defined by a focal distance of a focal device covering the first ambient light sensor.

3. The apparatus of claim 2, wherein the focal device has a predetermined focal distance of one meter or less.

4. The apparatus of claim 2, wherein the focal device comprises a wide-angle lens, a Fresnel lens, a light pipe, or a combination thereof.

5. The apparatus of claim 2, wherein the focal device provides a first zone of proximity detection and a second zone of proximity detection for the ambient light sensor.

6. The apparatus of claim 1, comprising:
in the calibration mode:
receive a first signal from a second ambient light sensor, the second ambient light sensor disposed at a different position relative to the life safety device than the first ambient light sensor;
determine a second baseline ambient light level based on the first signal from the second ambient light sensor;
in the proximity detection mode:
receive a second signal from the second ambient light sensor;
compare the second signal from the second ambient light sensor to the second baseline ambient light level;
determine by a second analysis that a second difference in ambient light from the second baseline ambient light level indicates the presence of the object in proximity to the life safety device; and
issue the alert indicating the presence of the object in proximity to the life safety device based at least in part on the second analysis.

7. The apparatus of claim 6, wherein the proximity to the life safety device is defined by:
for the first ambient light sensor, a first focal distance of a first focal device covering the first ambient light sensor; and
for the second ambient light sensor, a second focal distance of a second focal device covering the second ambient light sensor, the second focal distance being different from the first focal distance.

8. The apparatus of claim 1, comprising:
in the proximity detection mode:
wherein the second signal from the first ambient light sensor is received at a first sampling frequency;
determine by a second analysis that a second difference in ambient light from the first baseline ambient light level indicates the presence of the object in proximity to the life safety device, the second analysis comprising:
receive a plurality of third signals from the first ambient light sensor at a second sampling frequency, the second sampling frequency being higher than the first sampling frequency;
calculate an average ambient light level based on at least two of the plurality of third signals received at the second sampling frequency;
compare the average ambient light level to the first baseline ambient light level; and
wherein the alert indicating the presence of the object in proximity to the life safety device is issued based at least in part on the second analysis.

9. The apparatus of claim 1, comprising:
an artificial intelligence circuit communicatively coupled to the at least one control circuit;
in a learning mode, the artificial intelligence circuit to:
receive an input to confirm or to deny the presence of an object in proximity to the life safety device; and
update a logic parameter for the control circuit based on the input.

10. The apparatus of claim 9, wherein to update the logic parameter comprises to adjust a weight factor associated with the difference in ambient light from the baseline.

11. A method comprising:
in a calibration mode:
receiving a first signal from a first ambient light sensor of a life safety device;
determining a first baseline ambient light level for the life safety device based on the first signal from the first ambient light sensor;
in a proximity detection mode:
receiving a second signal from the first ambient light sensor;
comparing the second signal from the first ambient light sensor to the first baseline ambient light level;
determining by a first analysis that a first difference in ambient light from the first baseline ambient light level indicates a presence of an object in proximity to the life safety device, proximity defined by a focal distance of a focal device covering the first ambient light sensor; and
issuing an alert indicating the presence of the object in proximity to the life safety device based at least in part on the first analysis.

12. The method of claim 11, comprising:
in the proximity detection mode:
wherein the second signal from the first ambient light sensor is received at a first sampling frequency;
receiving a plurality of third signals from the first ambient light sensor at a second sampling frequency, the second sampling frequency being higher than the first sampling frequency;
calculating an average ambient light level based on at least two of the plurality of third signals received at the second sampling frequency;
comparing the average ambient light level to the first baseline ambient light level;
determining by a second analysis that a second difference in ambient light from the first baseline ambient light level indicates the presence of the object in proximity to the life safety device; and
issuing the alert indicating the presence of the object in proximity to the life safety device based at least in part on the second analysis.

13. The method of claim 11, comprising:
in a learning mode:
receiving an input to confirm or to deny the presence of an object in proximity to the life safety device; and
updating a logic parameter for the life safety device based on the input.

14. The method of claim 13, wherein updating the logic parameter for the life safety device comprises adjusting a weight factor associated with the difference in ambient light from the baseline.

15. The method of claim 11, comprising:
in the calibration mode:
receiving a third signal from a second ambient light sensor, the second ambient light sensor disposed at a different position relative to the life safety device than the first ambient light sensor;
determining a second baseline ambient light level based on the third signal from the second ambient light sensor;
in the proximity detection mode:
receiving a fourth signal from the second ambient light sensor;
comparing the fourth signal from the second ambient light sensor to the second baseline ambient light level;
determining by a second analysis that a second difference in ambient light from the second baseline ambient light level indicates the presence of the object in proximity to the life safety device; and
issuing the alert indicating the presence of the object in proximity to the life safety device based at least in part on the second analysis.

16. An article of manufacture, comprising a non-transitory machine-readable medium, the medium including instructions that, when loaded and executed by one or more control circuits of a life safety device, cause the one or more control circuits to:
in a calibration mode:
receive a first signal from a first ambient light sensor;
determine a first baseline ambient light level based on the first signal from the first ambient light sensor;
in a proximity detection mode:
receive a second signal from the first ambient light sensor;
compare the second signal from the first ambient light sensor to the first baseline ambient light level;
determine by a first analysis that a first difference in ambient light from the first baseline ambient light level indicates a presence of an object in proximity to the life safety device; and
issue an alert indicating the presence of the object in proximity to the life safety device based at least in part on the first analysis.

17. The article of manufacture of claim 16, wherein the instructions cause the one or more control circuits to:
in the proximity detection mode:
wherein the second signal from the first ambient light sensor is received at a first sampling frequency;
determine by a second analysis a second difference in ambient light from the first baseline ambient light level indicates the presence of the object in proximity to the life safety device, the second analysis comprising:
receive a plurality of third signals from the first ambient light sensor at a second sampling frequency, the second sampling frequency being higher than the first sampling frequency;
calculate an average ambient light level based on at least two of the plurality of third signals received at the second sampling frequency;
compare the average ambient light level to the first baseline ambient light level; and
issue the alert indicating the presence of the object in proximity to the life safety device based at least in part on the second analysis.

18. The article of manufacture of claim 16, wherein the instructions cause the one or more control circuits to:
in a learning mode:
receive an input to confirm or to deny the presence of an object in proximity to the life safety device; and
update a logic parameter for the life safety device based on the input.

19. The article of manufacture of claim 18, wherein to update the logic parameter for the life safety device comprises to adjust a weight factor associated with the difference in ambient light from the baseline.

20. The article of manufacture of claim 16, wherein the instructions cause the one or more control circuits to:
in the calibration mode:
receive a first signal from a second ambient light sensor, the second ambient light sensor disposed at a different position relative to the life safety device than the first ambient light sensor;
determine a second baseline ambient light level based on the first signal from the second ambient light sensor;
in the proximity detection mode:
receive a second signal from the second ambient light sensor;
compare the second signal from the second ambient light sensor to the second baseline ambient light level;
determine by a second analysis that a second difference in ambient light from the second baseline ambient light level indicates the presence of the object in proximity to the life safety device; and
issue the alert indicating the presence of the object in proximity to the life safety device based at least in part on the second analysis.
